(19) United States
(12) Patent Application Publication
(10) Pub. No.: US 2017/0370615 A1
(43) Pub. Date: Dec. 28, 2017

(54) APPARATUS AND METHOD FOR RAPID DRAIN OF WATER HEATER

(71) Applicant: Nasser Chamanbahar, Englewood, CO (US)

(72) Inventor: Nasser Chamanbahar, Englewood, CO (US)

(21) Appl. No.: 15/635,020

(22) Filed: Jun. 27, 2017

Related U.S. Application Data
(60) Provisional application No. 62/355,194, filed on Jun. 27, 2016.

(51) Int. Cl. F24H 9/00; G01L 19/00

(52) U.S. Cl. CPC F24H 9/0042; G01L 19/0007

(57) ABSTRACT

The present disclosure provides a gas connection assembly for rapid draining of water heaters. The gas connection assembly includes a first channel having a gas inlet connection that connects to a gas supply source, a second channel having a gas outlet connection assembly configured to connect to a water heater, and a third channel coupled to a pressure regulator having a gas relief. The first, second, and third channels are connected such that a gas from the gas supply source comes through the first channel and distributes into the second channel and the third channel.

### CROSS-REFERENCE TO RELATED APPLICATION

This application claims the benefit of U.S. Provisional Application No. 62/355,194, filed on Jun. 27, 2016, which is hereby incorporated by reference herein for all purposes.

### FIELD

The present disclosure is directed to an apparatus and methods for assisting rapid water drain from a water heater or other vessel.

### BACKGROUND

Water and sediment may be drained and removed from hot water heaters through a drain, which is commonly located generally adjacent to the bottom of the water heater tank. The hot water heater tank is conventionally drained by gravity. However, this draining is often very slow, takes hours to drain the water heater, and fails to completely remove all the water or sediment from the tank.

In many parts of the country, dealing with hard water is a necessity. For example, well water is hard and includes a substantial amount of calcium and magnesium. The well water also includes particulates, which can cause metals to rust. Even with a softener and a particulate filter, sediments are generally deposited at the bottom of the water heaters and thus reduce the efficiency of the water heaters. The sediments may also be deposited in the drain of the water heaters and thus reduce the draining speed from the water heaters.

There remains a need to develop an apparatus and methods for improving the draining speed and also reducing the sediment deposits for hot water heaters.

### BRIEF SUMMARY

The present disclosure provides an apparatus including a gas supply source and a gas connection assembly for rapid draining of water heaters.

In an embodiment, the gas connection assembly includes a main body, which includes a first channel having a gas inlet connection configured to connect to a gas supply source. The main body also includes a second channel having a gas outlet connection assembly configured to connect to a water heater. The main body further includes a third channel coupled to a pressure regulator having a gas relief, wherein the first channel, the second channel, and the third channel are coupled generally adjacent to a center region of the main body such that a gas from the gas supply source comes through the first channel and distributes into the second channel and the third channel.

In an embodiment, a method is provided for draining water from a water heater. The method includes connecting a gas supply to a water heater from a top end and applying a pressure to drain water from the water heater. The method also includes turning off a cold water supply for the water heater and connecting the gas connection assembly to a hot water outlet of the water heater. The drain in the water heater is then opened, gas from a gas supply source is applied to the water heater from a top end and water and sediment is then forced out of the water heater at a bottom end of the water heater.

In some embodiments, the method further includes adjusting a pressure regulator to reduce from a first pressure of a gas supply source to a second pressure inside a gas connection assembly and closing a valve of the gas supply source to stop the gas supply to the gas connection assembly.

In some embodiments, the method also includes monitoring the gas pressure by using a pressure indicator gauge.

Additional embodiments and features are set forth in part in the description that follows, and will become apparent to those skilled in the art upon examination of the specification or may be learned by the practice of the disclosed subject matter. A further understanding of the nature and advantages of the present disclosure may be realized by reference to the remaining portions of the specification and the drawings, which forms a part of this disclosure.

### BRIEF DESCRIPTION OF THE DRAWINGS

The description will be more fully understood with reference to the following figures and data graphs, which are presented as various embodiments of the disclosure and should not be construed as a complete recitation of the scope of the disclosure, wherein:

FIG. 1 is a hot water heater in an embodiment.

FIG. 2 illustrates an apparatus configured to connect to the hot water outlet of the water heater of FIG. 1 in an embodiment.

FIG. 3A illustrates a gas connection assembly in an embodiment.

FIG. 3B illustrates a gas connection assembly in an embodiment.

FIG. 4 is a cross-sectional view of the gas connection assembly in an embodiment.

FIG. 5 is a water heater with a side arm in an embodiment.

FIG. 6 describes an example method of draining a water heater.

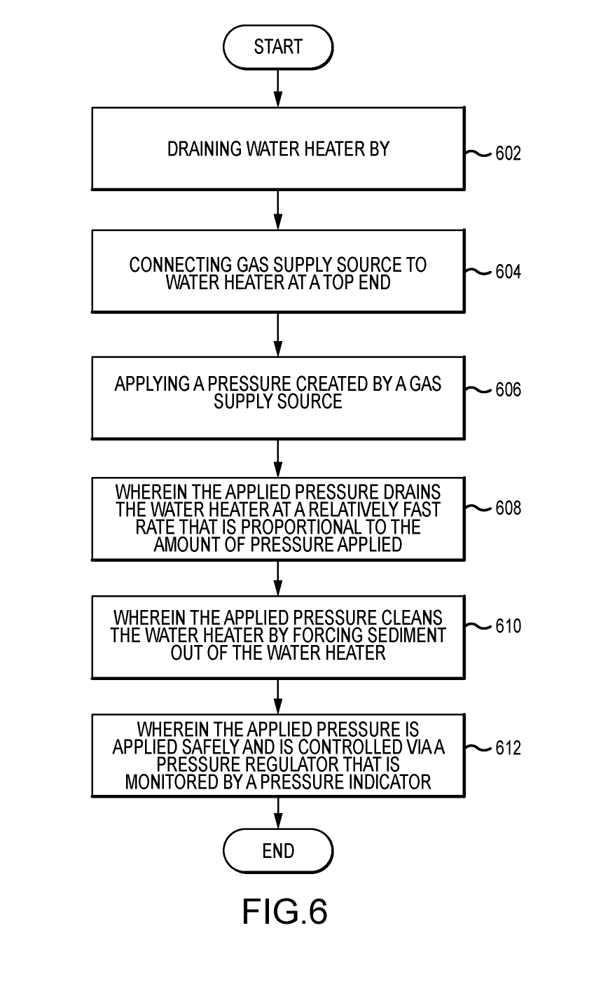

FIG. 7 describes a method of draining a water heater.

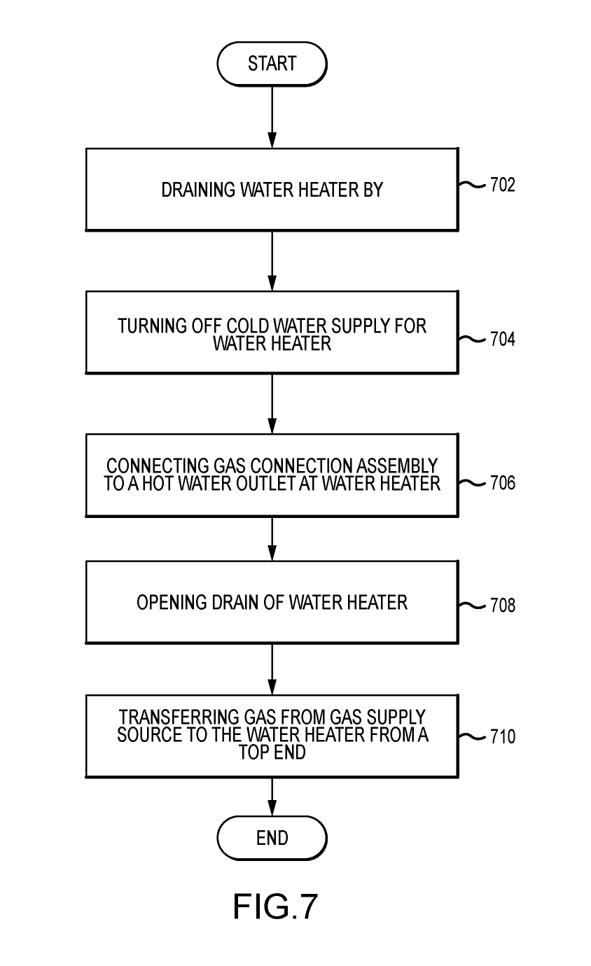

### DETAILED DESCRIPTION

The present disclosure may be understood by reference to the following detailed description, taken in conjunction with the drawings as described below. It is noted that, for purposes of illustrative clarity, certain elements in various drawings may not be drawn to scale.

The present disclosure provides an apparatus and methods for rapidly draining a water heater. The apparatus includes gas supply source and also a gas connection assembly coupled between the gas supply source and a hot water outlet of a water heater. The apparatus can help assist a technician to drain a water heater more quickly, more safely, and more completely than conventional draining by gravity by applying gas pressure from top end of the water heater.

The apparatus also can help direct the drain water to another location with an incline, in cases where there is no drainage at the site of the water heater. For example a garden hose may be connected to the drain of the water heater and help direct water to another site.

The apparatus also provides a more effective way of removing sediments without disturbing the sediments as with conventional means. The apparatus can remove an accumulation of sediments from the hot water heater without utilizing the pressure and temperature valve.

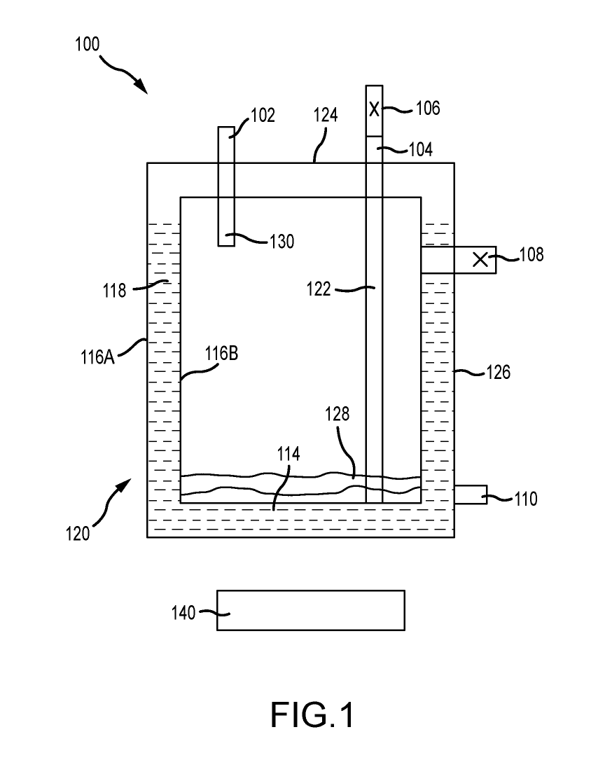

FIG. 1 is a hot water heater in an embodiment. Hot water heater 100 includes a water heater tank 120, a cold water inlet 104 near a top end 124, and also a hot water outlet 102 near the top end 124. The water heater tank 120 includes an outer wall 116A and an inner wall 116B, and also a thermal insulation 118 between the outer wall 116A and the inner wall 116B. The water heater 100 also includes a shut off valve 106 by the cold water inlet 104.

The water heater also includes a heater 140, such as a gas burner, near the bottom end 114 for heating the water in the water heater tank 120. The water heater 100 also includes an internal pipe 122 that guides the cold water from the top end 124 to a bottom end 114 of the water heater tank 120, such that the cold water is heated by the heater 140 located near the bottom end 114 of the water heater 100. The hot water heater 100 further includes a pressure and temperature (P & T) control valve 108 on a sidewall 126 for relief of the pressure inside the inner wall 116B of the water heater tank 120. The P & T valve 108 is located near the top end 124. The hot water heater also includes a drain 110 on the side wall 126 near the bottom end 114.

The hot water heater 100 may also include an internal tube 130 connected to the hot water outlet 102 near the top end 124, which guides the hot water out of the water heater tank 120. The hot water moves toward the top end 124, while the cold water moves toward the bottom end 114 through the internal pipe 122.

During conventional draining of the water heater tank 120, cold water from a tap may be pressed down under a pressure of about 80 psi through the internal pipe 122 to the bottom end 114. The cold water stirs the water near the bottom end 114, and thus causes less sediments to flow out through the drain 110. As such, the conventional draining causes buildup of the sediments 128 near the bottom end 114, and reduces the heating efficiency of the water heater 100. The sediments 128 include calcium and/or magnesium containing minerals, and are thermal insulators, such that the deposition of the sediments near the bottom of the water heater would reduce the heating efficiency of the water heater 100.

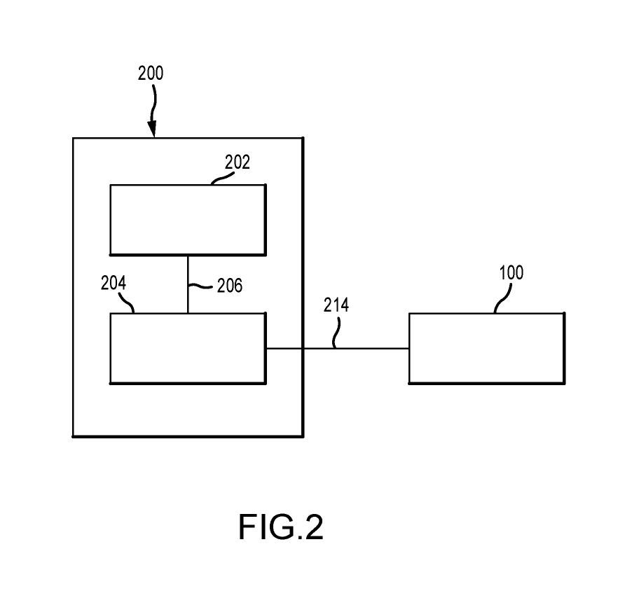

FIG. 2 illustrates an apparatus 200 configured to connect to the hot water outlet of the water heater of FIG. 1 in an embodiment. The apparatus 200 is used for rapid water drain from the water heater 100. Apparatus 200 includes a gas supply source 202. The gas supply source 202 may be a compressed nitrogen (N₂) tank, a compressed carbon dioxide (CO₂) tank, or an air tank. The gas supply source 202 may also be a hand/foot gas pump.

Apparatus 200 also includes a gas connection assembly 204, which couples the gas supply source 202 to a hot water outlet 102 of a water heater 100. The gas connection assembly 204 couples to the gas supply source 202 by a first gas hose 206. The gas connection assembly 204 may couple to the hot water outlet 102 of the water heater 100 by a second gas hose 214. Alternatively, the gas connection assembly 204 may couple to the water heater 100 directly without the second gas hose 214.

During preventive maintenance for draining water from the water heater 100, the gas is transferred from the gas supply source 202 through the gas connection assembly 204 to the water heater 100. The gas from the hot water outlet 102 is used to press down the water and increases the draining speed through the drain 110 of the water heater 100.

The apparatus 200 provides benefits over the conventional draining method. For example, embodiments may significantly increase the amount, and rate at which water and sediment is drained from the hot water heater tank during preventive maintenance. The drain speed may be about ten times faster than the conventional draining by gravity. Another benefit is to remove the accumulated sediment more effectively, because the present invention does not stir the accumulated sediments like the cold water does in the conventional method. By reducing the deposit or build-up of sediments at the bottom of the water heater tank, the heating efficiency of the water heater can be significantly improved. Also, the buildup of the sediments at the drain slows down the water drain from the tank.

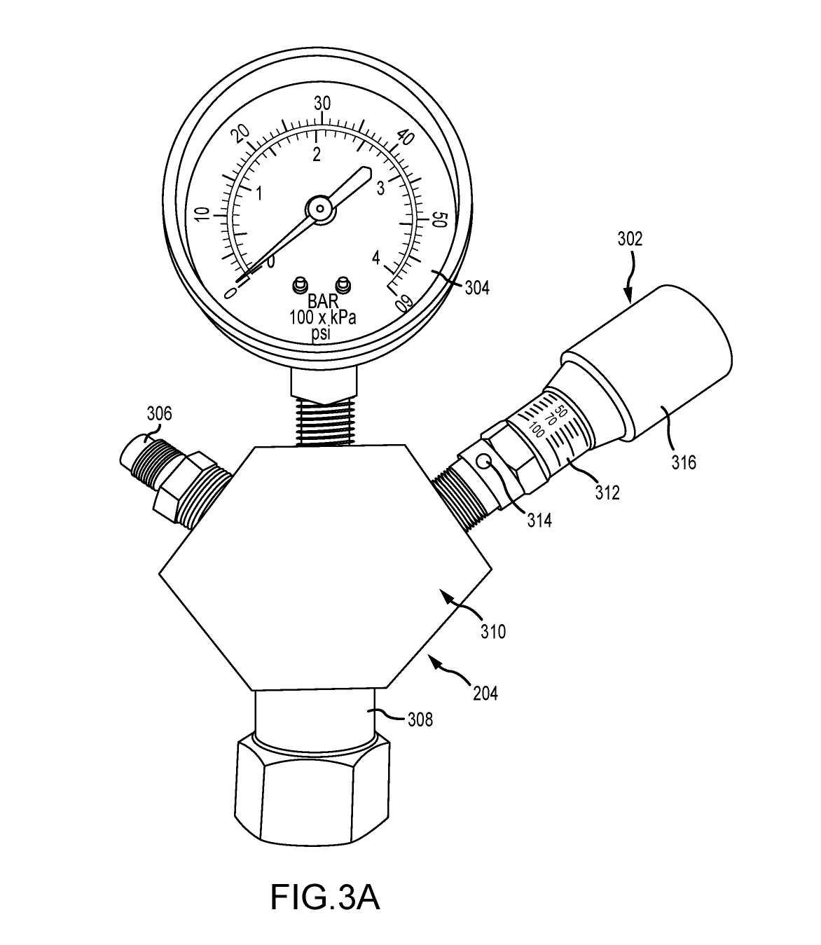

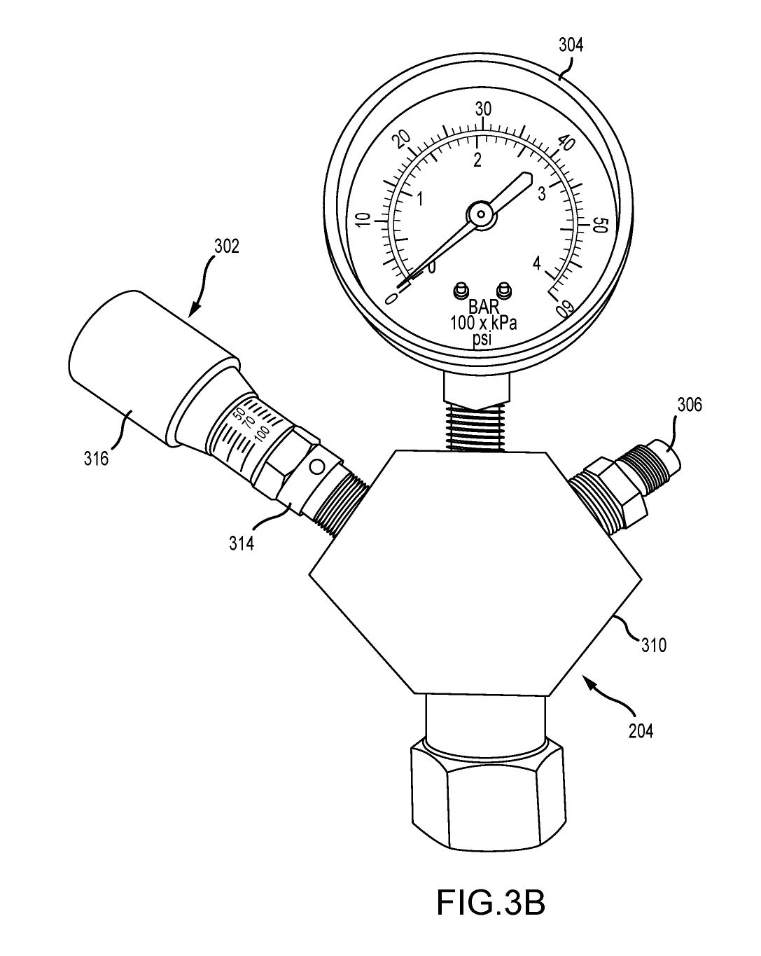

FIG. 3A illustrates a gas connection assembly 204 in an embodiment. As shown, the gas connection assembly 204 may include a central main body 310, which includes a gas inlet connection 306 that connects to the gas supply source 202 and also a gas outlet assembly 308 configured to connect to the hot water outlet 102 of the water heater 100. The hose 214 may be coupled between the gas outlet assembly 204 and the hot water outlet 102 of the water heater 100 to transfer the gas from the gas supply source 202 to the water heater 100.

The gas connection assembly 204 may include a pressure regulator 302 for reducing the gas pressure from the gas supply source 202. The pressure regulator 302 includes a pressure relief 314 for reducing the gas pressure from the gas supply source 202. The pressure regulator 302 is coupled to the main body 310.

In an embodiment, the pressure regulator 302 may include a pressure label 312, for example, from 10 psi to 100 psi with increments of 10 psi. The pressure label may also include 10, 20, 30, 40, 50, 60, 70, 80, 90, and 100 psi with an increment of 10 psi. The label 312 can be adjusted by rotating a knob 316. The pressure regulator 302 reduces the gas pressure to a lower pressure than the pressure in the compressed gas tank. For example, the compressed gas tank may have a pressure of 200 psi. The pressure regulator 302 may set the gas pressure at approximately 30 psi. Generally, higher pressure may speed up the water draining. If there is no leak in the water heater tank, the gas pressure may be adjusted to be higher to speed up the drain. If the gas comes out of the pressure relief 314 from the pressure regulator 302, the gas supply source 202 containing CO₂, N₂ or air should be shut down.

The gas connection assembly 204 may also include a pressure indicator gauge 304 for monitoring the gas pressure inside the main body 310. The pressure indicator gauge 304 is also coupled to the main body 310.

The pressure indicator gauge 304 can provide measurements of the pressure inside the main body 310 of the gas connection assembly 204. The pressure indicator gauge 304 may be attached to the gas connection assembly 204.

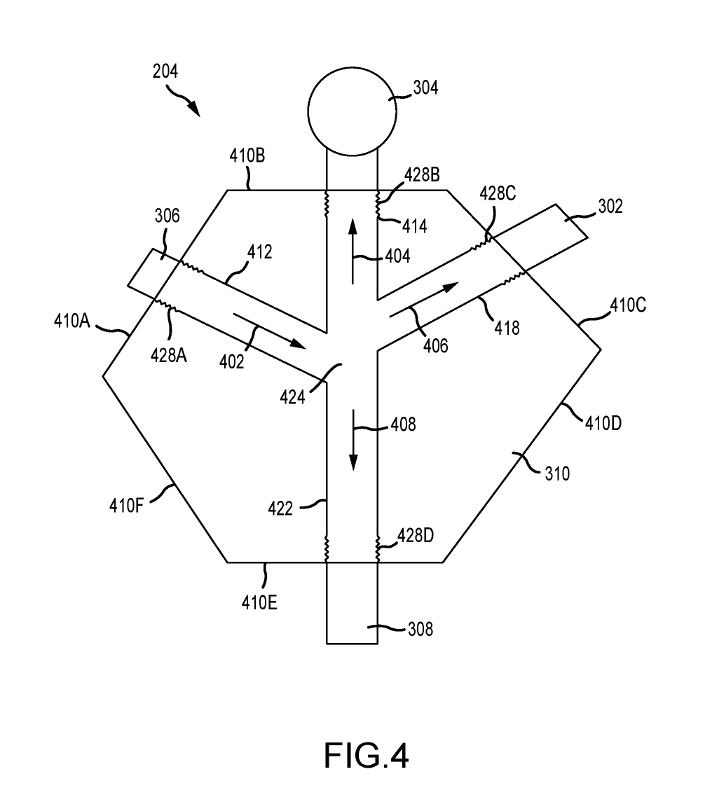

As shown in FIGS. 3A, 3B and 4, the main body 310 is shaped in a polygon plate. In this example, the polygon plate includes six sides 410A-F, or generally hexagonally shaped. The pressure indicator gauge 304 is located on a center top side 410B. The gas inlet is located on one left side 410A of the main body 310, next to the pressure indicator gauge 304. The pressure regulator 302 is located on a right side 410C symmetric to the gas inlet connection 306. The gas outlet assembly 308 is on a bottom side 410E opposite to the pressure indicator gauge 304.

FIG. 3B is an illustration of a gas connection assembly in an alternative embodiment. As shown, the pressure regulator 302 is shown to the left side of the pressure indicator 304, while the gas inlet is on the right side of the pressure indicator 304. The pressure indicator gauge 304 is on a top side and the gas outlet assembly is on a bottom side opposite to the pressure indicator gauge 304.

The arrangement of the gas inlet, the gas outlet assembly, the pressure regulator and the pressure indicator gauge may vary to vary the characteristics of the apparatus. The shape and dimension of the main body of the gas connection assembly may also vary.

FIG. 4 is a cross-sectional view of the gas connection assembly of FIG. 3A in an embodiment. The central main body 310 has an outer wall 410 shaped in a polygon plate. The central main body 310 includes first, second, third and fourth channels 412, 422, 414 and 418, respectively, which are connected near a center region 424. The gas inlet 306 coupled to the gas supply source 202. As pointed by an arrow 402, the incoming gas from the gas inlet 306 flows through the first channel 412, and flows to the water heater attachment assembly 308, as pointed by an arrow 408 through second channel 422, also flows through the third channel 414 to the pressure indicator gauge 304, as pointed by an arrow 404, and also flows to the pressure regulator 302 through fourth channel 418 as pointed by an arrow 406. The four channels may be helpful for guiding the gas flow toward the water heater assembly or other toward other portions of the apparatus. The gas pressure inside the central body 310 remains uniform because the apparatus is made of a rigid material such as aluminum block stainless steel, or other materials able to withstand the pressures of the system.

The main body 310 may be made of a metal, for example, an aluminum alloy. A thick plate of metal may be machined to form a polygon plate that has a substantially uniform thickness. Then, the polygon plate may be drilled to form the four channels 412, 414, 418, and 422. Then, internal threads 428A, 428E, 428C, and 428B may be produced on sides 410A, 410E, 410C, and 410B for attaching the gas inlet connection 306, the gas outlet assembly 308, the pressure regulator 302, and the pressure indicator gauge 304, respectively.

As shown above, the apparatus 200 can work with various hot water heaters, for example, as shown in FIG. 1. Alternatively, the apparatus 200 can also work with other heaters, such as side arm heaters. Side arm heaters may often be found in old homes or houses.

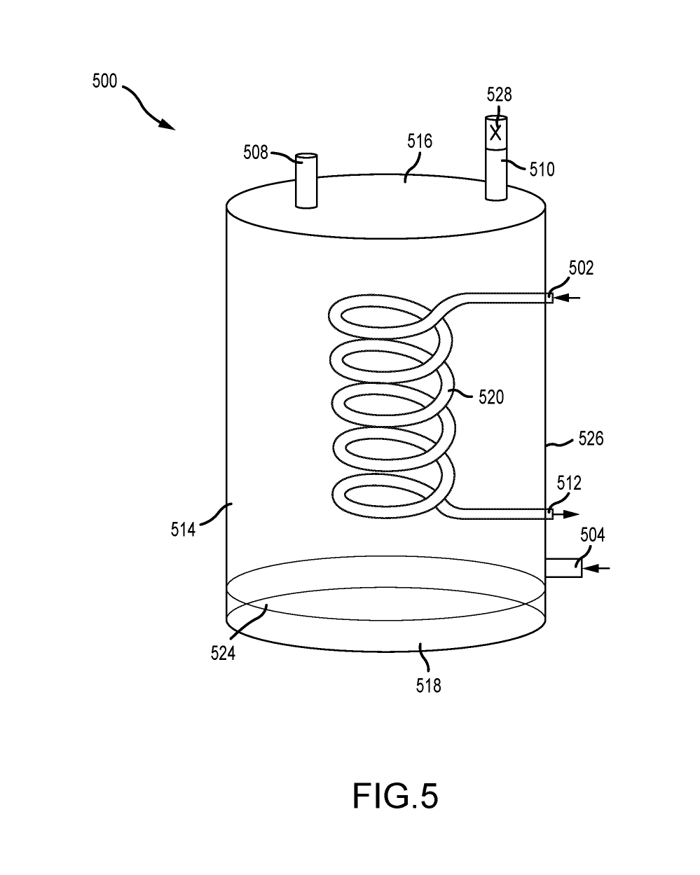

FIG. 5 is a water heater with a side arm heater in an embodiment. The side arm heater 500 includes a water heater tank 514 containing hot water. The side arm heater 500 also includes a hot water outlet 508 and a cold water inlet 510 near a top end 516. The cold water inlet 510 is at a distance from the hot water outlet 508. The cold water inlet 510 is coupled to a shut off valve 528 for controlling the water flow into the water heater tank 514. The side arm heater 500 also includes a drain 504 on a side wall 526 near the bottom end 518.

Unlike water heater 100, the side arm heater 500 includes a metal tube 520 inside the hot water heater tank 514, rather than the gas burner 140 near the bottom end 114 of the water heater 100. The metal tube 520 is generally connected to a boiler (not shown) to receive hot fluid for heating the water inside the water heater tank 514. The metal tube 520 includes an inlet 502 on side wall 526 close to the top end 516 for the hot fluid from the boiler. The metal tube 520 also includes an outlet 512 on side wall 526 close to the bottom end 518 for the hot fluid to return to the boiler.

The metal tube 520 may be made of copper, which has very good thermal conductivity. The hot fluid inside the metal tube may include water and antifreeze (glycol). Sometimes, the copper tube 520 may leak the antifreeze to the heated water inside the water heater tank 514 and contaminate the heated water. When the heated water is used by a user, the contaminated water may cause health issues. For these reasons, the side arm heaters 500 are less commonly used today.

Without the apparatus 200, sediments 524 may deposit near the bottom end 518. When the apparatus 200 is connected to the hot water outlet 508, the gas from the gas supply source would help accelerate draining from the side arm water heater 500. The sediments 524 may become thinner because of the effective draining.

### Operational Method

One requirement of preventive maintenance is to drain all water in the water heater for heater winterization. For example, when a homeowner is out of the house during the winter, it is desirable to remove the water from the hot water heater tank to prevent damage to the water heater when the house is not heated. The conventional draining method by gravity takes a very long time, for example, hours, if not longer.

Conventional draining also produces additional problems. For example, a technician may leave the job site to do other jobs while the water drains from the heater and may forget to close the drain. When the heater needs to be restarted next year, another technician may not be aware of the open drain and assumes that the drain is closed. The technician may turn on the heater without shutting off the drain, which may cause flooding in the house. Also, a technician may not completely remove the water from the tank because it takes too long to do so. When another technician comes the following year, he or she may open the drain causing the remaining water to flood the house. All these problems can be solved by using apparatus 200 for rapid water draining from the water heater 100.

Generally, the method includes providing a gas supply source 202 to the hot water heater 100 from a top end 124 and applying a pressure to drain water from the water heater 100. The pressure may be moderate and may not exceed more than 30 psi for safety purposes. The method may also include controlling the pressure regulator 302 to adjust the gas pressure to the hot water storage tank. The pressure regulator 302 reduces the pressure to be at a lower pressure than the pressure in the compressed gas tank. For example, the gas tank has a pressure of 200 psi. The pressure regulator 302 may set a gas pressure of 30 psi. If there is no leak in the water heater 100 tank, the gas pressure may be adjusted to be higher to speed up the draining from the water heater 100, but never exceed 100 psi.

If the gas pressure is higher than a pressure limit, such as 30 psi, there may be leak in the wall of the water heater 100. The wall 116A and/or 116B may have a weld region which may be more susceptible to bursting or popping under high gas pressure. The gas limit may vary with the types of heaters or the ages of the heaters. Generally, older heaters may have lower pressure limits than newer heaters.

The pressure regulator 302 includes a pressure relief 314 for reducing the gas pressure from the gas tank. If the gas comes out the pressure relief 314 from the pressure regulator 302, the gas tank containing CO₂ or N₂ should be shut down.

In a particular embodiment, the method 702 for draining water from a water heater 100 includes (a) turning off a cold water supply 104 to the water heater 100 (collectively 704); (b) connecting the gas connection assembly 204 to a hot water outlet 102 of the water heater 100 (collectively 706); (c) opening a drain 110 of the water heater 100 (collectively 708); and (d) transferring gas from a gas supply source 202 to the water heater 100 from a top end 124 for draining the water from water heater 100 (collectively 710).

The method also includes connecting a gas supply source 202 to a water heater 100 from a top end 124 (collectively 604) and applying a pressure created by the gas supply source 202 to drain the water heater 100 (collectively 606). The applied pressure drains the water heater 100 at a relatively fast rate that is substantially proportional to the amount of pressure applied to the water heater 100 (collectively 608). The applied pressure generally cleans the water heater by forcing and draining substantially all sediment 128 out of water heater 100 (collectively 610). The applied pressure is applied safely and is controlled via the pressure regulator 302 that can be visually monitored by a user via the pressure indicator 304 (collectively 612).

The method also includes adjusting a pressure regulator 302 to reduce from a first pressure of a gas supply source 202 to a second pressure inside a gas connection assembly 204 and closing a valve of the gas supply source 202 to stop the gas supply 202 to the gas connection assembly 204.

The method may also include monitoring the pressure by using the pressure indicator gauge 304. Caution must be taken when the apparatus 200 is used. For example, the apparatus 200 cannot be used, when the hot water heaters 100 are leaking or have thin walls as a result of rusting over time. The gas pressure may cause the water storage tank 120 to disperse. If a leak is detected, the gas is shut off to prevent damage to the hot water heater 100 during the preventive maintenance.

Additional uses and methods of the present invention are also possible including, for example, to check a water heater for leaks by applying pressure to the water heater 100 and by monitoring the water heater 100 to see if any gas or air escapes the water heater at any specific point of the side walls 116A and/or 116B of the water heater 100. The present invention can also be used to drain or “blow-out” a sprinkler system by applying pressure to the sprinkler system thereby draining the water from the system in a similar method as described herein.

Having described several embodiments, it will be recognized by those skilled in the art that various modifications, alternative constructions, and equivalents may be used without departing from the spirit of the invention. Additionally, a number of well-known processes and elements have not been described in order to avoid unnecessarily obscuring the present invention. Accordingly, the above description should not be taken as limiting the scope of the invention.

Those skilled in the art will appreciate that the presently disclosed embodiments teach by way of example and not by limitation. Therefore, the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A method for draining a water heater comprising:
connecting a gas supply source to a water heater generally adjacent a top end of the water heater; and
applying a pressure created at least in part by the gas supply source, wherein the applied pressure drains the water heater at a relatively fast rate that is substantially proportional to the amount of pressure applied to the water heater, wherein the applied pressure generally cleans the water heater by forcing and draining substantially all sediment and water out of the water heater, and
wherein the applied pressure is applied safely and is controlled at least in part via a pressure regulator that can be visually monitored by a user via a pressure indicator.

2. The method of claim 1, further comprising:
adjusting the pressure regulator to reduce from a first pressure of a gas supply source to a second pressure inside a gas connection assembly; and
closing a valve of the gas supply source to stop the gas supply to the gas connection assembly.

3. The method of claim 2, wherein the first pressure is about 200 psi.

4. The method of claim 2, wherein the second pressure ranges from 10 psi to 100 psi.

5. The method of claim 2, wherein the second pressure is 30 psi.

6. The method of claim 1, wherein the gas tank contains at least one of N₂, CO₂, or air.

7. The method of claim 1, further comprising shutting off the gas supply source if a leak is noticed.

8. The method of claim 1, wherein the water heater comprises at least one of a heater having a gas burner or a side arm heater having an internal thermal conductive tube.

9. The method of claim 1, further comprising monitoring the gas pressure by using a pressure indicator gauge.

10. A gas connection assembly comprising:
a main body including:
a first channel having a gas inlet connection configured to connect to a gas supply source;
a second channel having a gas outlet connection assembly configured to connect to a water heater or vessel; and
a third channel coupled to a pressure regulator having a gas relief portion, wherein the first channel, the second channel, and the third channel merge generally near a center region of the main body such that a gas from the gas supply source travels through the first channel and distributes into the second channel and the third channel.

11. The gas connection assembly of claim 10, wherein the main body further comprises a fourth channel connected to a pressure indicator configured to measure the pressure inside the gas connection assembly, wherein the fourth channel merges with the first channel generally near the center region.

12. The gas connection assembly of claim 2, further comprising a pressure created by the gas supply source that is applied to drain the water heater, wherein the applied pressure drains the water heater at a relatively fast rate that is substantially proportional to the amount of pressure applied to the water heater, wherein the applied pressure generally cleans the vessel by forcing and draining substantially all sediment and water out of the water heater, and wherein the applied pressure is applied safely and is controlled at least in part via the pressure regulator that can be visually monitored by a user via the pressure indicator.

13. The gas connection assembly of claim 10, wherein the pressure regulator comprises a plurality of settings of gas pressure generally from 10 psi to 100 psi at constant increments.

14. The gas connection assembly of claim 10, wherein the gas supply source comprises at least one of N₂, CO₂, and/or air.

15. The gas connection assembly of claim 10, wherein the gas supply source is shut down if there is a leak in the water heater and gas comes out of the pressure regulator.

16. The gas connection assembly of claim 10, wherein the outlet connection assembly is configured to connect to the hot water outlet through a hose.

17. The gas connection assembly of claim 10, wherein the main body comprises a generally polygonal shaped plate.

18. The gas connection assembly of claim 17, wherein the polygon plate has six sides.

19. The gas connection assembly of claim 18, wherein the first channel is located on a first side of the main body, the second channel is located on a second side of the main body, and the third channel is located on a third side of the main body.

20. A method for draining water from a water heater comprising:
turning off a cold water supply for the water heater;
connecting the gas connection assembly to a hot water outlet of the water heater;
opening a drain of the water heater;
transferring gas from a gas supply source to the water heater from a top end for draining the water from water heater.
